(19) United States
(12) Patent Application Publication
(10) Pub. No.: US 2017/0091384 A1
(43) Pub. Date: Mar. 30, 2017

(54) SYSTEMS AND METHODS FOR FITTING LD DISTRIBUTIONS AT GENOMIC SCALES

(71) Applicant: INTERNATIONAL BUSINESS MACHINES CORPORATION, Armonk, NY (US)

(72) Inventors: Niina S. Haiminen, Vahalla, NY (US); Laxmi P. Parida, Mohegan Lake, NY (US)

(21) Appl. No.: 14/867,462

(22) Filed: Sep. 28, 2015

(51) Int. Cl. G06F 19/28; G06F 19/18; G06F 19/12

(52) U.S. Cl. CPC G06F 19/28; G06F 19/12; G06F 19/18

(57) ABSTRACT

Embodiments are directed to a computer-based simulation system including an input circuit, a memory and a processor system communicatively coupled to the memory and the input circuit. The input circuit is configured to receive an input distribution. The processor system is configured to assign, for each marker of a simulated population matrix, a minor allele frequency. The processor system is further configured to assign, for each marker and each distance of the simulated population matrix, a linkage disequilibrium.

### BACKGROUND

The present disclosure relates in general to the computer-aided transformation of genetic populations. More specifically, the present disclosure relates to systems and methodologies for fitting LD distributions at genomic scales.

It is known to use computer-based simulation tools to understand the evolutionary and genetic consequences of complex processes. Computer-based simulation tools often involve a range of components, including modules for preparation, extraction and conversion of data, program codes that perform experiment-related computations, and scripts that join the other components and make them work as a coherent system that is capable of displaying desired behavior. Although these tools have traditionally been used in population genetics by a fairly small community with programming expertise, the rapid increase in computer processing power in the past few decades has enabled the emergence of sophisticated, customizable software packages for performing experiments in silico (i.e., on a computer or via computer simulation), whereby research is conducted with computer simulated models that closely reflect the real world.

In many studies, it is important to work with an artificial population to evaluate the efficacy of different methods or simply generate a founder population for an in silico breeding regimen. The populations are usually specified by a set of characteristics such as minimum allele frequency (MAF) distribution and LD distribution. An allele is one of a number of alternative forms of the same gene or same genetic locus. Allele frequency, or gene frequency, is the proportion of a particular allele among all allele copies being considered. It can be formally defined as the percentage of all alleles at a given locus in a population gene pool represented by a particular allele. LD is the non-random association of alleles at different loci. In other words, LD is the presence of statistical associations between alleles at different loci that are different from what would be expected if alleles were independently, randomly sampled based on their individual allele frequencies. If there is no LD between alleles at different loci, they are said to be in linkage equilibrium. LD is influenced by many factors, including the rate of recombination, the rate of mutation, genetic drift, the system of mating, population structure and genetic linkage. As a result, the pattern of LD in a genome is a powerful signal of the population genetic forces that are structuring it.

Simulating populations satisfying given LD, MAF and other distribution constraints is an important task for many studies. The applications span from in-silico plant breeding to disease susceptibility studies in humans. A generative model of simulations faces the challenge of an incomplete understanding of the population evolution process, while a non-generative approach can be agnostic to the process and yet produce populations satisfying the distribution constraints. However, this fidelity to the input constraints comes at a price, e.g., the resolution, or the number of markers, that can be effectively handled by the algorithm. The reason is that the non-generative approach works by simultaneously satisfying multiple constraints for each marker. Thus, orders of magnitude increase in the number of markers often reduce the tightness of fit to the given distributions.

While the problem of constructing a population that meets either MAF (minimum allele frequency) distribution or LD (linkage disequilibrium) distribution is known, it may be advantageous to provide systems and methodologies for combining the two requirements. Moreover, it may be advantageous to provide systems and methodologies for fitting multiple distributions (MAF and LD) at genomic scales, whereby the probabilistic transformation of the genetic populations utilizes incrementally scaled algorithms.

### SUMMARY

Embodiments are directed to a computer-based simulation system for assimilating simulated genome populations. In some aspects, the system comprises an input circuit configured to receive an input distribution of a simulated population matrix having a first marker resolution, a memory, and a processor system communicatively coupled to the memory and the input circuit. In some embodiments, the processor system may be configured to receive the input distribution, assign, for each marker of the simulated population matrix, a minor allele frequency (MAF), assign a linkage disequilibrium (LD) for each marker and each distance of the population matrix, assimilate the minor allele frequency, the linkage disequilibrium, and output a genetic marker dataset for a simulated population matrix having a second marker resolution.

Embodiments are further directed to a computer-based simulation method. The method may include receiving, using an input circuit, an input distribution of a simulated population matrix having a first marker resolution, assigning, for each marker of the simulated population matrix, a minor allele frequency (MAF) to a neighboring column of the population matrix, assigning a linkage disequilibrium (LD) for each marker and each distance of the population matrix, assimilating the minor allele frequency, the linkage disequilibrium, and outputting a genetic marker dataset for a simulated population matrix having a second marker resolution.

Other embodiments are directed to a non-transitory computer-readable medium. The medium may include instructions executable to cause a processor to perform a method for assimilating simulated genome populations. The method may include receiving, using an input circuit, an input distribution of a simulated population matrix having a first marker resolution, assigning, for each marker of the simulated population matrix, a minor allele frequency (MAF) to a neighboring column of the population matrix, assigning a linkage disequilibrium (LD) for each marker and each distance of the population matrix, assimilating the minor allele frequency, the linkage disequilibrium, and outputting a genetic marker dataset for a simulated population matrix having a second marker resolution.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts a diagram illustrating a distribution used as inputs characteristics according to one or more embodiments;

FIG. 2 depicts an output matrix illustrating an example of a genetic population that satisfies the input characteristics of the distribution shown in FIG. 1;

FIG. 3 depicts an exemplary computer system capable of implementing one or more embodiments of the present disclosure;

FIG. 4 depicts a diagram illustrating a genetic population modeling system according to one or more embodiments;

FIG. 5 depicts a flow diagram illustrating an overall methodology according to one or more embodiments;

FIG. 6 depicts a diagram illustrating the limits on LD (i.e., r²) imposed by assigning the MAFs according to the system shown in FIG. 4 and the methodology shown in FIG. 5;

FIG. 7 depicts a perturbation calculation for determining a distance (D) according to one or more embodiments;

FIG. 8 illustrates an Algorithm 1 that may be applied to assign LD constraints according to one or more embodiments;

FIG. 9 depicts a combination of combinatoric solution methods and linear algebra solution methods, which may be used in developing an algebraic combinatorial algorithm to generate a population according to one or more embodiments;

FIG. 10 depicts the linear algebraic equations of FIG. 9 in a format that facilitates the use a standard solver for integer programming (IP) according to one or more embodiments;

FIG. 11 depicts a more explicit expression of the linear algebraic equations of FIG. 10 according to one or more embodiments;

FIG. 12 depicts an Algorithm 2 that may be applied to generate a population with MAF constraints and LD constraints according to one or more embodiments;

FIG. 13 depicts an exemplary set of constraints according to one or more embodiments;

FIG. 14 depicts constraints for incremental fitting according to one or more embodiments;

FIG. 15 depicts a method for probabilistic transformation of a genetic population according to one or more embodiments;

FIG. 16 depicts a method for interpolating constraints according to one or more embodiments;

FIG. 17 depicts an exemplary output of a high resolution genetic distribution according to one or more embodiments; and

FIG. 18 depicts a computer program product in accordance with one or more embodiments.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

Computational biology is the science of using biological data to develop algorithms and relations among various biological systems in order to quickly analyze and interpret relevant information. The field is broadly defined and includes foundations in computer science, applied mathematics, animation, statistics, biochemistry, chemistry, biophysics, molecular biology, genetics, genomics, ecology, evolution, anatomy, neuroscience and visualization.

As previously noted herein, it is known to use computer-based simulation tools to understand the evolutionary and genetic consequences of complex processes. Computer-based simulation tools often involve a range of components, including modules for preparation, extraction and conversion of data, program codes that perform experiment-related computations, and scripts that join the other components and make them work as a coherent system that is capable of displaying desired behavior. Although these tools have traditionally been used in population genetics by a fairly small community with programming expertise, the rapid increase in computer processing power in the past few decades has enabled the emergence of sophisticated, customizable software packages for performing experiments in silico (i.e., on a computer or via computer simulation), whereby research is conducted with computer simulated models that closely reflect the real world. This increased capability to produce genetic data in silico, along with the greater availability of population-genomics data, are transforming how research is conducted in many domains, including for example genetic epidemiology, anthropology, evolutionary and population genetics and conservation. In silico experimentation provides researchers with a number of benefits, including higher precision and better quality of experimental data, better support for data-intensive research, access to vast sets of experimental data generated by scientific communities, more accurate simulations through more sophisticated models, faster individual experiments and higher work productivity.

In many studies, it is important to work with an artificial population to evaluate the efficacy of different methods or simply generate a founder population for an in silico breeding regimen. The populations are usually specified by a set of characteristics such as MAF distribution and LD distribution. An allele is one of a number of alternative forms of the same gene or same genetic locus. Sometimes, different alleles can result in different observable phenotypic traits, such as different pigmentation. However, most genetic variations result in little or no observable variation. Allele frequency, or gene frequency, is the proportion of a particular allele among all allele copies being considered. It can be formally defined as the percentage of all alleles at a given locus in a population gene pool represented by a particular allele. In other words, it is the number of copies of a particular allele divided by the number of copies of all alleles at the genetic place (locus) in a population.

Allele frequency is usually expressed as a percentage. Allele frequencies are used to depict the amount of genetic diversity at the individual, population, and species level. They are also the relative proportion of all alleles of a gene that are of a designated type. In population genetics, LD is the non-random association of alleles at different loci, i.e., the presence of statistical associations between alleles at different loci that are different from what would be expected if alleles were independently, randomly sampled based on their individual allele frequencies. If there is no LD between alleles at different loci, they are said to be in linkage equilibrium. LD is influenced by many factors, including the rate of recombination, the rate of mutation, genetic drift, the system of mating, population structure and genetic linkage. As a result, the pattern of LD in a genome is a powerful signal of the population genetic forces that are structuring it. LD may exist between alleles at different loci without any genetic linkage between them and independently of whether or not allele frequencies are in equilibrium (i.e., not changing with time).

The problem of generating simulated genetic population models may be stated as the problem of generating a population of “N” diploids (or “2N” haploids) with “M” bi-allelic single nucleotide polymorphisms (SNPs) given the following inputs: a MAFs “p” distribution, and an average LD (“r²”) distribution per genetic distance. MAF refers to the frequency at which the least common allele occurs in a given population. The parameters “p” and “r²” are typically derived from an existing population “P”, and the task is to generate a “perturbed” population P′ that shows similar characteristics as “P.” Known generative models that are used to simulate the population P′ generally rely on forward-simulation models and intermediate genetic populations. Specifically, known generative simulation models require the estimation of the founder population, its size, the number of generations, mutation, recombination rates and a host of other parameters that would eventually generate a population satisfying the given (input) characteristics. The techniques to estimate these population evolution parameters are not well-understood and usually involve simulation studies. However, according to some embodiments, forward simulation may not be used, and the output population can be generated directly from an input population, or from a given distribution of MAF and LD constraints.

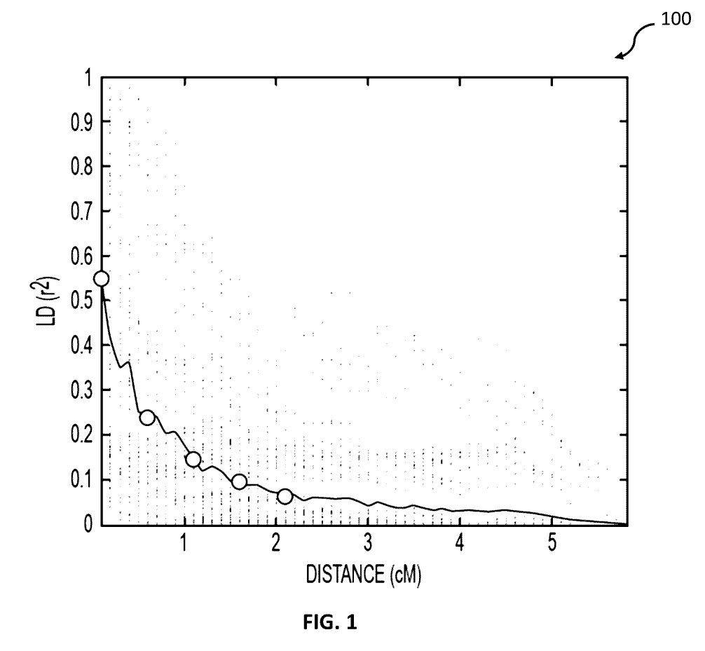

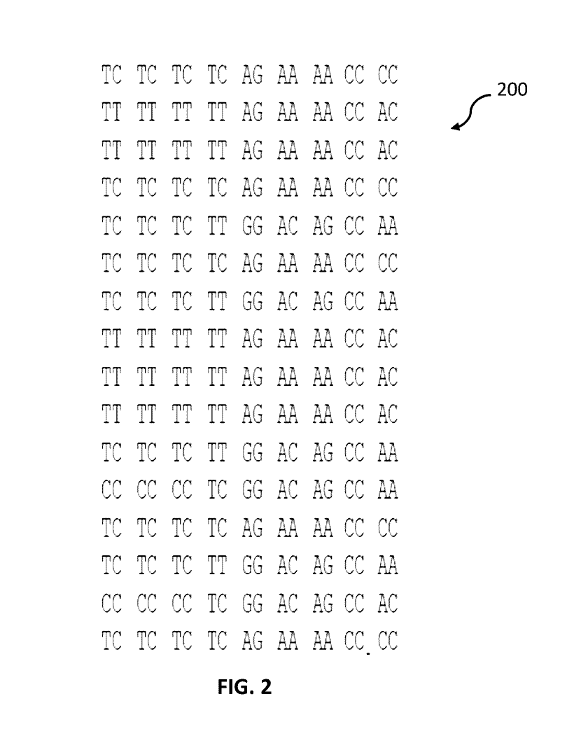

Turning now to the drawings in greater detail, wherein like reference numerals indicate like elements, according to one or more embodiments FIG. 1 depicts a diagram illustrating a distribution used as inputs characteristics, and FIG. 2 depicts an output matrix illustrating an example of a genetic population that satisfies the input characteristics of the distribution shown in FIG. 1. As previously noted, the problem of generating the simulated genetic population model represented by the matrix shown in FIG. 2 may be stated as the problem of generating a population of “N” diploids (or “2N” haploids) with “M” bi-allelic SNPs given the inputs depicted in FIG. 1, which are, namely, a MAFs “p” distribution, and an average LD “r²” distribution per genetic distance. The parameters “p” and “r²” are typically derived from an existing population “P”, and the task is to generate a “perturbed” population P′ that substantially matches existing population “P” by showing similar characteristics as existing population “P.” In other words, the task is to “simulate” the genetic population shown by the output matrix in FIG. 2 to substantially match the distribution shown in FIG. 1, which is typically a distribution observed in nature. The simulated output matrix in FIG. 2 includes rows and columns formed from pairs of letters, or pairs of nucleotides. Each row represents a different individual, and each column represents a different marker or position on the genome. If the matrix of data in FIG. 2 matches the distribution in FIG. 1, any statistics computed from the output matrix data should substantially match those observed from real data, such as the input distribution in FIG. 1.

Turning now to an overview of the present disclosure, one or more embodiments provide systems and methodologies for simulating final models of genetic populations directly based on a given LD distribution and without the need to use forward-simulation models and intermediate genetic populations. In accordance with one or more embodiments, target statistics for the simulated population are defined, and a population is generated that directly matches those statistics without forward in time or backward in time simulation, and without sampling from a known population. More specifically, the disclosed systems/methodologies observe the allele frequencies, which are the frequency of each letter at each column. The disclosed systems/methodologies then observe the “pairwise linkage” or LD statistic, which is a biological term that means a determination of whether these pairwise markers have similar patterns across adjacent makers. Having similar patterns across adjacent markers means the markers were inherited together. The LD statistic, which is also referred to as r², is computed across all possible pairs of markers, and the average for each distance is computed. For example, from marker 1 to marker 3, the distance would be 2. LD is computed for all the possible pairs of markers that are a distance 2, and the average is computed, which should match the LD (r²) of the input distribution shown in FIG. 1.

In accordance with one or more embodiments of the present disclosure, the allele frequencies are assigned before the LD is assigned/computed in order to provide more flexibility because the assignment/computation of LD depends on the allele frequencies. This ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Thus, the disclosed systems and methodologies directly generate LD at the desired level, and linear algebra techniques are combined and utilized in a unique way to enable the direct simulation of a population P′ having the input characteristics “p” and “r².”

At least the features and combinations of features described in the immediately preceding paragraphs, including the corresponding features and combinations of features depicted in the FIGS., amount to significantly more than implementing a method of simulating final models of genetic populations in a particular technological environment. Additionally, at least the features and combinations of features described in the immediately preceding paragraphs, including the corresponding features and combinations of features depicted in the FIGS., go beyond what is well-understood, routine and conventional in the relevant field(s).

The systems and methodologies of the present disclosure facilitate the incorporation of linear algebraic solution techniques with combinatoric solution techniques to improve the accuracy, speed, efficiency and effectiveness of the overall solution. In general, combinatorics is a branch of mathematics concerning the study of finite or countable discrete structures. Aspects of combinatorics include counting the structures of a given kind and size (enumerative combinatorics), deciding when certain criteria can be met, and constructing and analyzing objects meeting the criteria (as in combinatorial designs and matroid theory), finding “largest”, “smallest”, or “optimal” objects (extremal combinatorics and combinatorial optimization), and studying combinatorial structures arising in an algebraic context, or applying algebraic techniques to combinatorial problems (algebraic combinatorics). Additionally, because the output matrix, generated in accordance with the present disclosure, is simulated data that has similar characteristics to real data, it can be used in a variety of ways. For example, the output matrix could be used to study disease models for human populations, or to make predictions about how a real population may behave under certain conditions, or to improve breeding simulators for plant breeding by providing more accurate initial populations for the simulators.

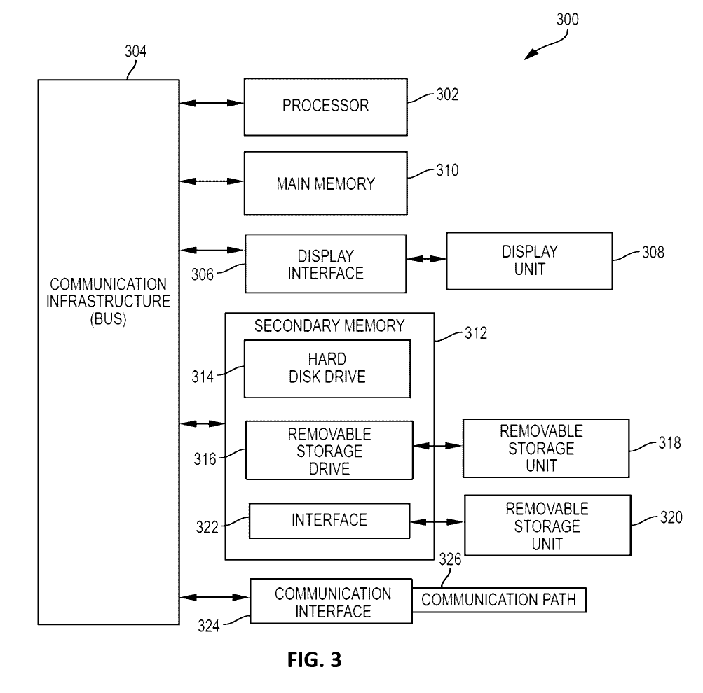

Turning now to a more detailed description of the present disclosure, FIG. 3 illustrates a high level block diagram showing an example of a computer-based simulation system 300 useful for implementing one or more embodiments. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional system are in communication via communication path 326, e.g., to communicate data between them.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by removable storage drive 316. As will be appreciated, removable storage unit 318 includes a computer readable medium having stored therein computer software and/or data.

In alternative embodiments, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM, or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etcetera. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310 and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

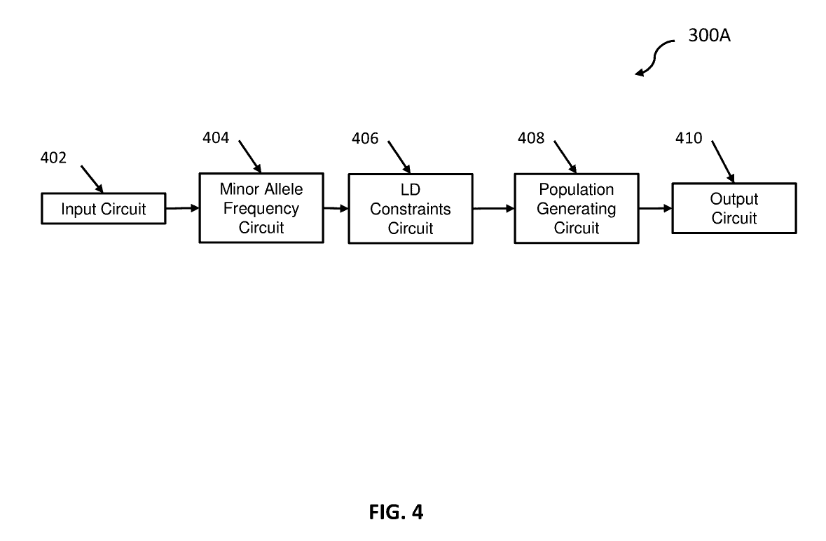

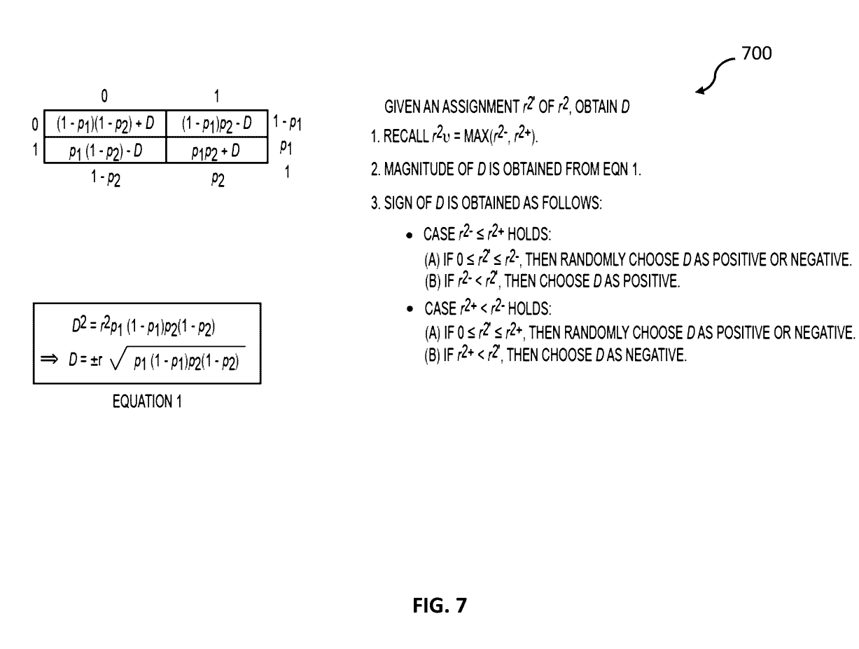

FIG. 4 depicts a diagram illustrating a more detailed implementation of a computer-based simulation system 300A useful in implementing one or more embodiments of the present disclosure. Computer system 300A includes an input circuit 402, a MAF circuit 404, a LD constraints circuit 406, a population generating circuit 408 and an output circuit 410, configured and arranged as shown. In operation, input circuit 402 receives an input distribution of the type shown in FIG. 1. Circuits 404, 406, 408, 410 generate the simulated output matrix (shown in FIG. 2) in accordance with the present disclosure such that the simulated output matrix matches the input distribution (shown in FIG. 1). MAF circuit 404 assigns, for each marker j=M, a MAF pⱼ. LD constraints circuit 406 assigns LD constraints r²_{j,h}, for each marker j and distance h=1, . . . j−1. Population generating circuit 408 generates a population having constraints pⱼ and r²_{j,h}. The functionality of LD constraints circuit 406 and population generating circuit 408 may be implemented by linear algebraic computational techniques, examples of which are illustrated in FIGS. 7 to 12 and described in greater detail later in this disclosure. Because, according to the present disclosure, greater flexibility is provided by assigning the allele frequencies before the LD is assigned/computed, this ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Output circuit 410 generates the simulated population matrix in the format shown in FIG. 2 having N diploids at M markers.

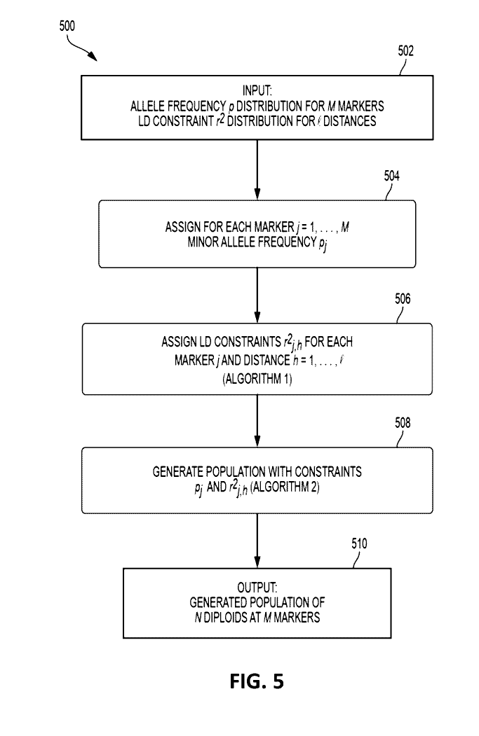

FIG. 5 depicts a flow diagram illustrating an overall methodology 500 for generating a simulated output matrix according to one or more embodiments. Methodology 500 begins at block 502 by receiving an input distribution of the type shown in FIG. 1. Blocks 504, 506, 508, 510 generate the simulated output matrix (shown in FIG. 2) in accordance with the present disclosure such that the simulated output matrix matches the input distribution (shown in FIG. 1). Block 504 assigns, for each marker j=1, . . . M, a MAF pⱼ. Block 506 assigns LD constraints r²_{j,h}, for each marker j and distance h=1, . . . j−1. Block 508 generates a population having constraints pⱼ and r²_{j,h}. The functionality of blocks 506, 508, similar to the functionality of LD constraints circuit 406 and population generating circuit 408 (each shown in FIG. 4) may be implemented by linear algebraic computational techniques, examples of which are illustrated in FIGS. 7 to 12 and described in greater detail later in this disclosure. As previously noted herein, because, according to the present disclosure, greater flexibility is provided by assigning the allele frequencies before the LD is assigned/computed, this ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Output circuit 410 generates the simulated population matrix in the format shown in FIG. 2 having N diploids at M markers.

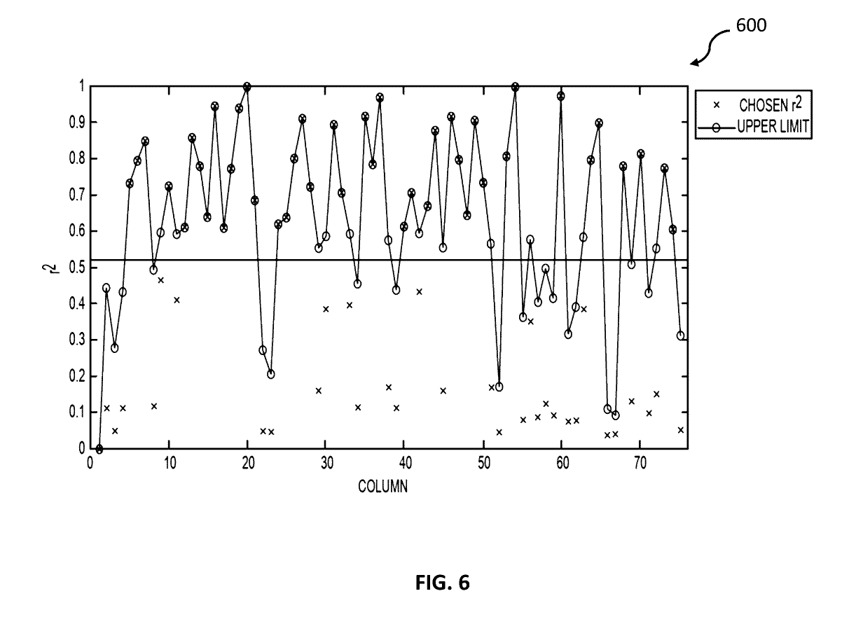

Additional detail of the functionality of circuits 406, 408 (shown in FIG. 4) and blocks 506, 508 (shown in FIG. 5) will now be described with reference to FIGS. 6 to 12. As previously noted herein, according to one or more embodiments markers are assigned as an initial step, which allows known algebraic methods to be used as the algorithm to solve the equations once all the constraints are in place. FIG. 6 depicts a diagram illustrating the limits on LD (e.g., r²) imposed by assigning the MAFs according to system 300A shown in FIG. 4 and methodology 500 shown in FIG. 5. Specifically, FIG. 6 illustrates, for one specific distance at each generated column (SNP), the limits (circles) for r² imposed by the allele frequencies and selected r² values. By assigning MAF in circuit 404 and block 504, upper limits are imposed on the assignment of r² for each column/marker.

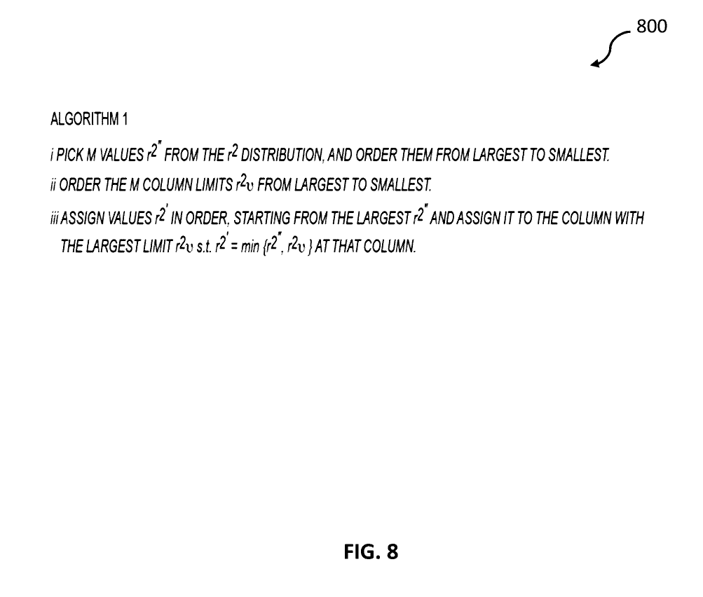

FIG. 7 illustrates a perturbation calculation for determining a distance (d) in implementing circuit LD constraints circuit 406 (shown in FIG. 4) and block 506 (shown in FIG. 5). FIG. 8 illustrates an Algorithm 1 that may be applied in assigning LD constraints in LD constraints circuit 406 and block 506.

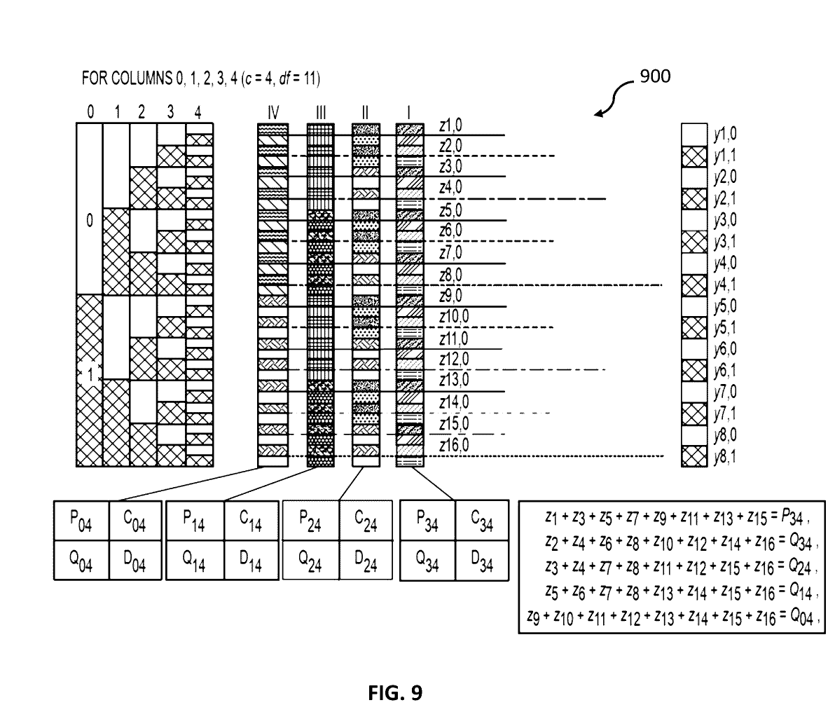

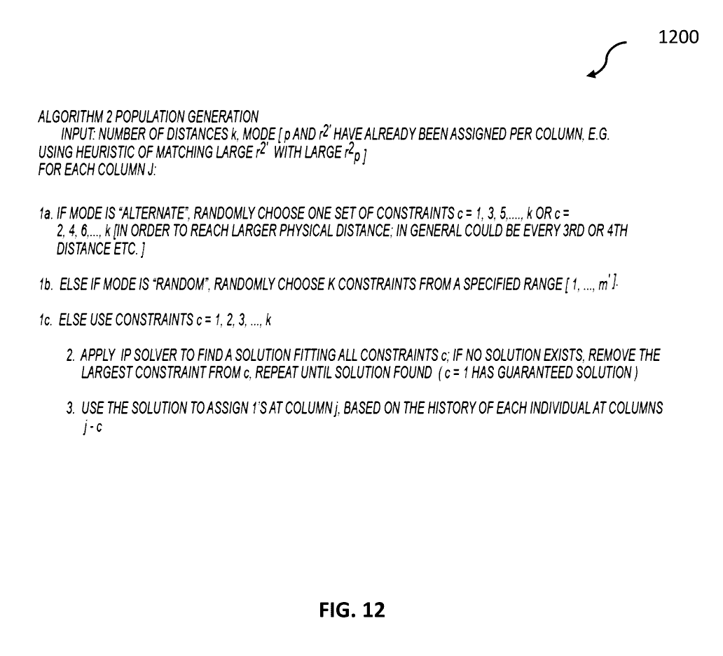

FIG. 9 depicts a combination of combinatoric solution methods and linear algebra solution methods, which may be used in developing an algebraic combinatorial algorithm (e.g., Algorithm 2 shown in FIG. 12) to generate the population. FIG. 9 focuses on columns 0, 1, 2, 3 and 4 (i.e., c=4, and df=11). Because of the disclosed manner in which the constraints are computed, and because of the disclosed manner in which the constraints are assigned, there is wide flexibility in the choice of algorithms to satisfy the constraints. The diagram of FIG. 9 demonstrates the pairwise constraints up to a distance 4, along with how the problem is modeled as the linear algebraic equations shown in the lower right hand corner of FIG. 9. The letters P₃₄, Q₃₄, Q₂₄, Q₁₄, and Q₀₄ are the actual values that are obtained from the r² constraint.

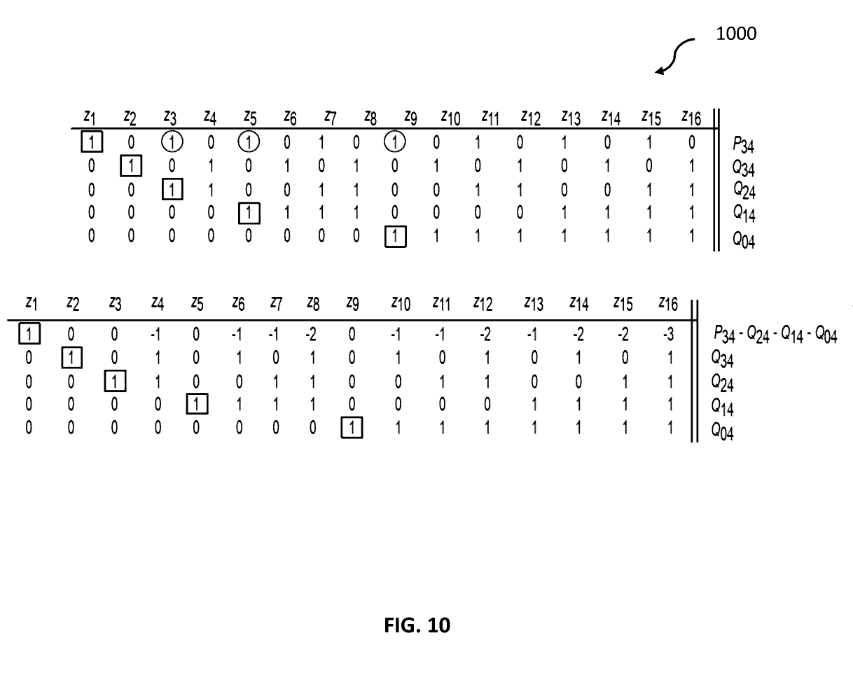

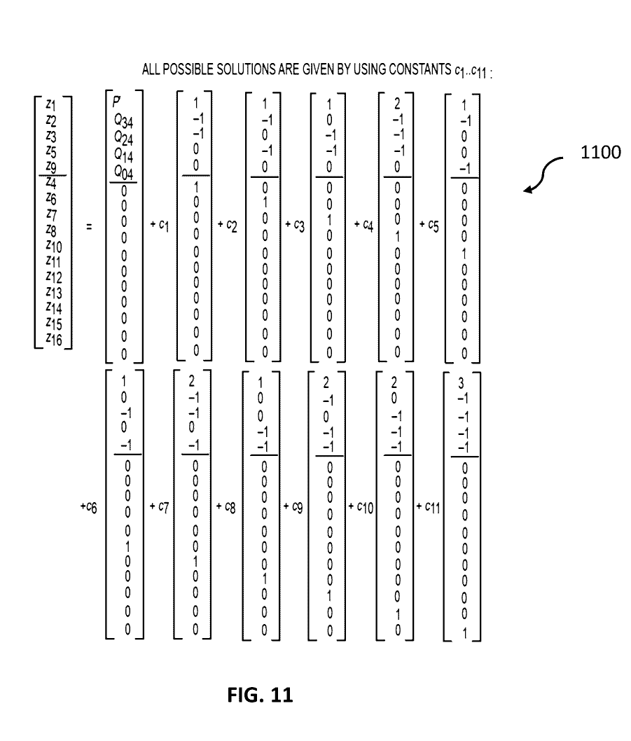

FIG. 10 provides substantially the same the linear algebraic equations of FIG. 9 but in a different format, which is chosen to facilitate the use a standard solver for integer programming (IP) to solve these equations and obtain the elements z₁, z₂, z₃, et seq., which will be the solution to the matrix problem. FIG. 11 provides a more explicit recitation of the equations in FIG. 10.

FIG. 12 depicts an Algorithm 2 that may be applied to generate a population with MAFs constraints and LD constraints according to population generating circuit 408 (shown in FIG. 4) and block 508 (shown in FIG. 5). Operation 1 of Algorithm 2 provides alternative implementation under 1a, 1b and 1c.

The present disclosure provides systems and methodologies for simulating final models of genetic populations directly based on a given MAF and LD distributions and without the need to use forward-simulation models and intermediate genetic populations. In accordance with one or more embodiments, target statistics for the simulated population are defined, and a population is generated that directly matches those statistics without forward in time or backward in time simulation, and without sampling from a known population.

The embodiments described thus far may facilitate the incorporation of linear algebraic solution techniques with combinatoric solution techniques to improve the accuracy, speed, efficiency and effectiveness of the overall solution. In accordance with the present disclosure, the allele frequencies are assigned before the LD is assigned/computed in order to provide more flexibility because the assignment/computation of LD depends on the allele frequencies. This ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Thus, the disclosed systems and methodologies directly generate LD at the desired level, and linear algebra techniques are combined and utilized in a unique way to enable the direct simulation of a population P′ having the input characteristics “p” and “r².” Because the output matrix, generated in accordance with the present disclosure, is simulated data that has similar characteristics to real data, it can be used in a variety of ways. For example, the output matrix could be used to study disease models for human populations, or to make predictions about how a real population may behave under certain conditions.

While the problem of constructing a population that meets either MAF distribution or LD distribution has been described thus far according to some disclosed embodiments, combining the two requirements may lead to complex computational scenarios. A generative model of simulation can face the same challenge of having an incomplete understanding of the population evolution process, while a non-generative approach can be agnostic to the process and yet produce populations satisfying the distribution constraints. However, the fidelity to the input constraints comes at a computational price, e.g., the resolution, or the number of markers in the population, that can be effectively handled by the processor and/or the algorithm operating on the processor.

A non-generative approach can work by simultaneously satisfying multiple constraints for each marker. Thus, orders of magnitude increases may be realized in the number of markers, which may reduce the tightness of the fit to a given distribution. In the following FIGS., the embodiments for fitting multiple distributions (e.g., MAF and LD) at genomic scales are contemplated. The solution for fitting the two disparate distributions can be based on incrementally scaling an algorithm based on non-generative algorithmic approaches, which are described in embodiments hereafter.

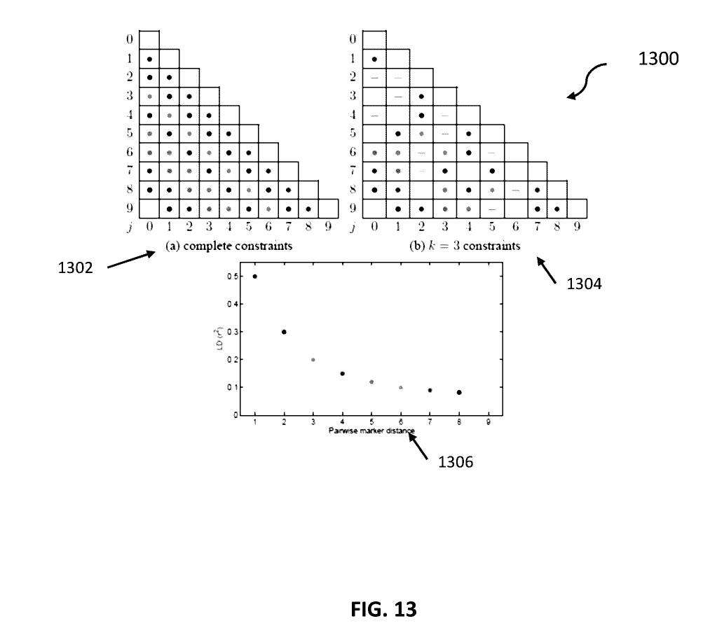

Referring now to FIG. 13, an incremental approach to fitting pairwise constraints 1300 is depicted. A constraint space 1304 is shown, which depicts 10 markers having limited information (e.g., the markers have low resolution). As shown in constraint space 1302, a complete set of constraints is depicted. Said in another way, constraint space 1304 is a subset of constraint space 1302, but with missing genetic marker information. For example, each cell [a,b] in constraint space 1304 corresponds to the constraint between the markers a and b. A dash (‘-’) in cell [a,b] of constraint space 1304 indicates that the pairwise constraint of markers a and b is not considered by the algorithm, whereas an entry of bullet indicates otherwise. According to some embodiments, the l-distance constraints lie along a diagonal in the lower triangular matrix representation. In some aspects, the expected LD values may satisfy a particular relationship with the expected constraints. As seen in graph 1306, which shows an average of the constraints, pairwise marker distances are depicted with respect to LD (r²).

A total of 10 loci are shown in constraint space 1302 (numbered 0 to 9) along with all the possible pairwise constraints (as shown in 1302 as cells), which may be inter-related. For example, the locus 5 affects all the cells in row 5 and column 5, that is a total of 9 constraints. This holds for all the loci (0 to 9). Thus, the number of constraints is quadratic in the number of loci. Accordingly, for practical algorithms it may be advantageous to reduce the number of constraints from 9 to a predetermined number, for example, 3 constraints, for each marker as shown in constraint space 1304. Using the example of 3 constraints, at least three constraints would need to be satisfied for each marker.

However, the magnitude of the constraint in terms of the LD value decreases as the values are considered down the diagonal to the left bottom corner. In other words distance 1 has a higher magnitude than distance 2, and so forth, as shown in constraint space 1306. In the example depicted in FIG. 13, the magnitude of the constraint decays exponentially as distance between the loci increases. This demonstrates a possible preference order in the algorithm design. For instance, if the starting point is minimum LD between a pair, then the order may prefer more of higher magnitude LD, or constraints corresponding to shorter distance pairs. On the other hand, if the starting point was maximum LD, then the order of preference may be the longer distance first.

FIG. 13 demonstrates that, in some aspects, the complexity of the algorithm may vary in connection with k (the number of constraints for each marker). If the number of markers is very large, then so must be the number of constraints. Then the algorithm would be quadratic, making it prohibitively expensive for high density markers for large chromosomal segments. Therefore, according to some embodiments, it may be advantageous to scale the constraints using an incremental scaling algorithm.

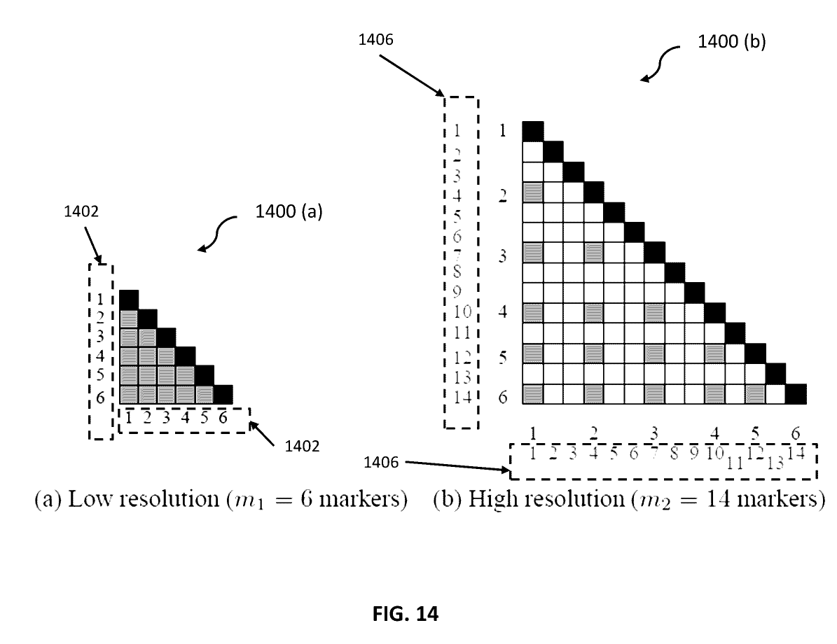

Referring now to FIG. 14, low resolution constraint space 1400(a) is depicted according to some embodiments. The respective cells (shown as squares) correspond to an LD value of +1. Low resolution columns 1402 are depicted as columns 1, 2, . . . , 6. Referring now to constraint space 1400(b), the high resolution column numbers 1406 are depicted as columns 1, 2, . . . , 14. It should be appreciated that column 1 of 1400(a) corresponds to column 1 of 1400(b); column 2 of 1400(a) corresponds to column 4 of 1400(b); column 3 of 1400(a) to column 7 of 1400(b); column 4 of 1400(a) corresponds to 10 of 1400(b); column 5 of 1400(a) corresponds to 12 of 1400(b); and column 6 of 1400(a) corresponds to 14 of 1400(b). Accordingly, φ(1)=1, φ(2)=4, φ(3)=7, φ(4)=10 φ(5)=12, and φ(6)=14. According to some embodiments, output circuit 410 may obtain the values shown as dark cells in constraint space 1400(b) directly from the output shown in constraint space 1400(a). In some aspects, at graph 1400(b), output circuit 410 may estimate the missing LD values as shown in FIG. 14, which correspond to the higher density LD constraints. The higher density LD constraints are depicted as lighter color cells.

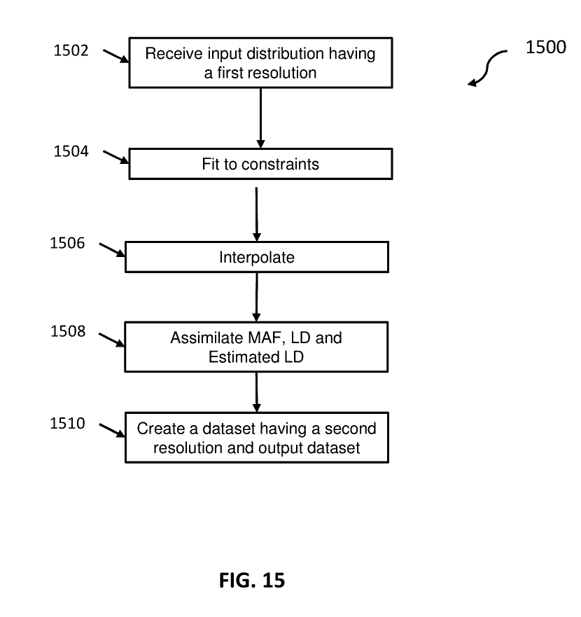

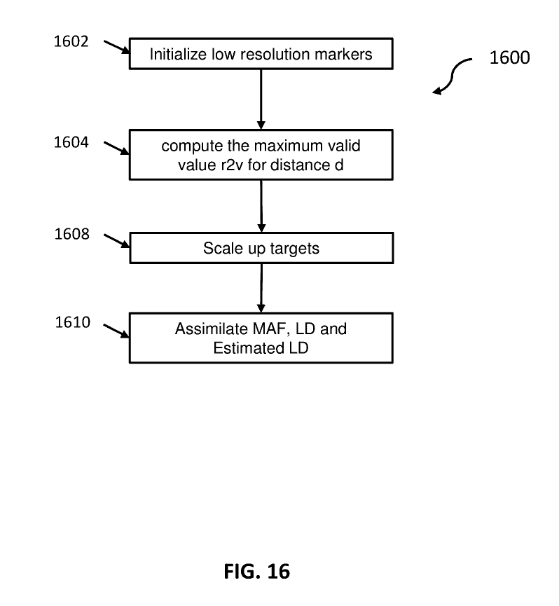

By way of an overview, FIGS. 15 and 16 depict exemplary methods for probabilistic transformation of a genetic population, according to some embodiments. Referring now to FIG. 15, as depicted in block 1502, output circuit 410 may receive an input distribution having a first resolution, and save the input distribution to an operatively connected computer memory. As depicted in FIG. 1400(a), the input distribution may have low resolution (e.g., be missing information). The resolution may be low with respect to a second output resolution (that can be higher resolution) as depicted in FIG. 14 in constraint space 1400(b). At block 1504, output circuit 410 may assign minor allele frequencies (MAF) to a respective neighboring column of each input MAF.

In some aspects, output circuit 410 may assign allele frequencies using predetermined constraints. For example, in one aspect, let the markers be jᵢ=1, 2, . . . , mⱼ. Output circuit 410 may set the value Lₘ(a, b) to the LD value between markers a and b where m markers are being used. In some embodiments Lₘ(a, a)=+1 for all values of m. At resolution with m₁ markers, LD constraints circuit 406 may use the algorithm depicted in FIG. 7. Thus, in one aspect, Lₘ₁ (a, b) is well defined for 1≧a<b≦m₁. FIG. 14 depicts one exemplary embodiment of the m₁ having 6 markers and m₂ having 14 markers.

As shown in block 1506, LD constraints circuit 406 may fit the input distribution to constraints by assigning either linkage disequilibrium (LD) for each marker. For example, in some embodiments, LD constraints circuit 406 may extract low resolution markers and set r²=1. LD constraints circuit 406 may extract the LD constraints for the low resolution markers, and set r²=1 at distance d=0. In some embodiments, LD constraints circuit 406 may implement the following incremental fitting algorithm to fit lower resolution constraints to higher resolution constraints.

First, for m₂>m₁, LD constraints circuit 406 may set the markers to be j₂=1, 2, . . . , m₂ and a map φ:jᵢ→j2 such that if a<b then φ(a)≦φ(b). Note that, according to some embodiments,

Lₘ₂(φ(a),φ(b))=Lₘ₁(a,b),1≦a<b≦m₁.

Then, LD constraints circuit 406 may assign markers c and d such that there does not exist any a with φ(a)=c or d. Accordingly, these are the new markers or columns.

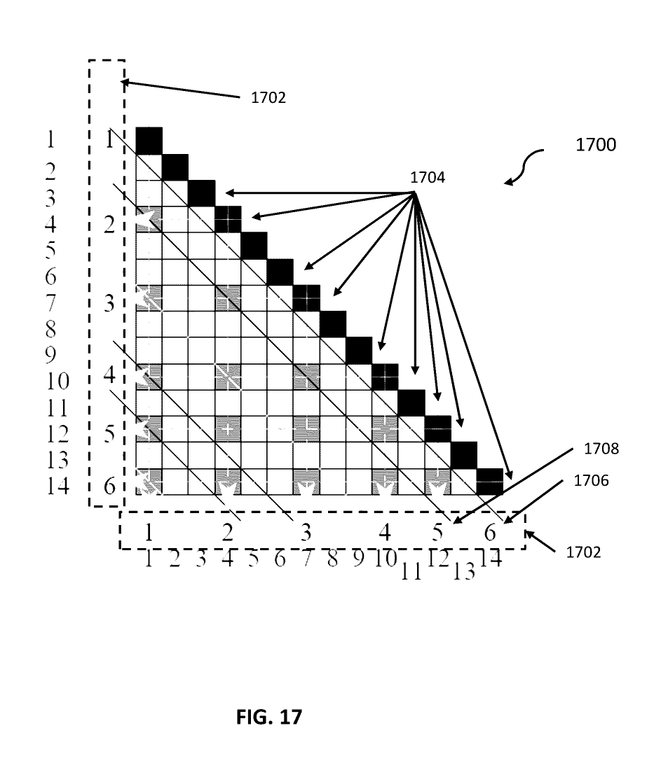

LD constraints circuit 406 may subsequently interpolate the values of Lₘ₂ (c, d), where at least one of c and d is a new marker, and where the values are interpolated from the adjacent values (as shown in FIG. 17) and discussed hereafter.

In some aspects, population generating circuit 408 may then solve k-CMP for k conditions. Each condition corresponds to a pair-wise LD value at distance d. In some embodiments, population generating circuit 408 may estimate the distribution (or expected value) of distance d from the values Lₘ₂ (a, b) with d=|a−b|. According to some embodiments, since only an estimate may be needed, Lₘ₂ may not need to be completely filled: as long as there are fₘ₂ well-defined cell entries, for some small fraction f.

After fitting to constraints, as shown in block 1504, LD constraints circuit 406 may interpolate the constraints at block 1506 by assigning the set of target values to the columns. FIG. 16 depicts an exemplary method for interpolating according to some embodiments.

Referring now to FIG. 16, after computing the valid range for each column pair and the target r² at block 1506, LD constraints circuit 406 may now assign the set of target values to the columns. At block 1506, LD constraints circuit 406 had previously sorted both sets and assigned the targets to the column pairs so that the largest targets go to columns with largest ranges. However, in some embodiments, the average of the target values may still lie below a predefined mean, because the valid ranges may represent a cutoff upper limit to the r² values. In order to ensure the average is met exactly (when possible), LD constraints circuit 406 may interpolate constraints by performing the following interpolation algorithm:

First, as depicted in block 1602, LD constraints circuit 406 may initialize m×1 table of available space per column, S, as zero. Initialize missing space M=0.

At block 1604, for each column j, LD constraints circuit 406 may compute the maximum valid value r²ᵥ for distance d, as shown above. In some embodiments, LD constraints circuit 406 may let the target value for column j be r²ₜ. If r²ᵥ≧r²_{f}, LD constraints circuit 406 may assign r²=r²ₜ and store remaining space S[j] to memory such that S[j]=r²ᵥ−r²ₜ, or alternatively, assign r²=r²ᵥ and increase missing space M to satisfy M=M+(r²ₜ−r²ᵥ).

As shown in block 1608, if M>0 then LD constraints circuit 406 may set scaler s=min(1, M/ΣS) and assign r²=r²+S[j]s. In some aspects, at block 1608, LD constraints circuit 406 may scale up the targets wherever space remains, such that the target average is met, if possible.

More specifically, LD constraints circuit 406 may interpolate the constraints for a higher resolution MAF and LD constraint from the lower resolution constraints. With respect to MAF constraints, LD constraints circuit 406 may assign each interpolated marker to be the MAF of the left or the right of a neighboring column. In some embodiments, LD constraints circuit 406 may make each choice randomly. Similar MAF for adjacent high resolution markers may ensure higher values for the LD, since the limits of possible pairwise LD can depend on the similarity of the pairwise allele frequencies.

With respect to interpolating the LD constraints, LD constraints circuit 406 may extract LD constraints from the low resolution markers, and set r²=1 at distance d=0. In some embodiments, LD constraints circuit 406 may fit an exponential curve Z with two parameters to extracted LD constraint data having the first (low) resolution. In some aspects, this curve may define the average target values for all the possible distances, including d=1. In other aspects, LD constraints circuit 406 may perform the following algorithm for the constraint interpolation for distance d:

First, if some values for distance d are already defined by the low resolution markers then LD constraints circuit 406 may fill in the missing values for d by uniform random sampling with replacement from the existing values for d.

Next, LD constraints circuit 406 may fill in the remaining distances during the distances d−1 and d+r (where d−1<d is the largest distance that was filled in the previous step, similarly d+r>d). LD constraints circuit 406 may sample each value at random with replacement from either d−l (with probability pr=1/(1+r)) or d+r (with probability 1−pr).

Finally, if no smaller distances than d exist, such as, for example, d=1 then LD constraints circuit 406 may sample values uniformly at random with replacement from the existing smallest distance d′, and multiply them with a scaling value s=Z(d)/Z(d′). LD constraints circuit 406 may repeat this process for several iterations I (e.g., I=10), because it has been observed that with small population sizes the sampling may be fairly sensitive to the random selections. In some aspects, for each distance, LD constraints circuit 406 may choose the set of values whose average is closest to Z(d) defined above. Thus, LD constraints circuit 406 may set the constraint for each distance by originating each respective distance from a different iteration.

Referring again to FIG. 16, after interpolating the constraints, as shown at block 1608, LD constraints circuit 406 may assimilate the distributions MAF and the LD constraints at block 1610. Accordingly, LD constraints circuit 406 may assign the MAF constraints per column and the pairwise LD constraints between columns, so that the overall distributions are satisfied. LD constraints circuit 406 may generate values using normal and gamma distributions for MAF and r².

In some embodiments, LD constraints circuit 406 may assign the MAF values to the columns and the LD values between the pairwise columns. Since the MAF assignment restricts the possible LD values (see Section “Valid range of r²”), high LD value (˜0.5) were not possible to obtain when the MAF values were randomly distributed among the columns. Therefore, in some aspects, LD constraints circuit 406 may generate genome segments of several adjacent columns with similar low MAF values.

In other aspects, LD constraints circuit 406 may assign the LD constraints by random, and adjust the constraints to meet the average targets. When MAFs of some pairwise columns do not allow for obtaining the desired LD for distance d, LD constraints circuit 406 may increase the other LD targets for distance d by a corresponding amount. Note that, based on the initial condition, (here zero or low LD) the target LD values may be lower than assigned due to the approximation. Therefore, according to some embodiments, a heuristic amount of 0.1 may be added to all the LD targets.

Returning, again, to FIG. 15, after fitting to constraints (as shown in block 1504), interpolating (as depicted in block 1506), and assimilating (as shown in block 1508), at block 1510, LD constraints circuit 406 may create a dataset having a second resolution using the assimilated distributions, and output the dataset.

FIG. 17 depicts exemplary output of a high resolution genetic distribution, according to some embodiments. Referring now to FIG. 17, the low resolution columns 1, 2, . . . , 6 are depicted in FIG. 17 as cells 1702. The high resolution column numbers are shown as 1, 2, . . . , 14. Cells 1702 represent LD values of +1. The dark cells have the values computed in the lower resolution. Lines 1704 show (generally) progressively decreasing values along the direction of the arrows.

According to some embodiments, LD constraints circuit 406 may interpolate the lighter cell values using the dark cell values. Then LD constraints circuit 406 may compute the pairwise LD average values along the left-to-right diagonal lines, which can then be implemented in the subsequent LD fitting algorithm. For instance when the line 1706 corresponds to a distance of 1, line 1708 corresponds to a distance of 3, and so on, in the high resolution example.

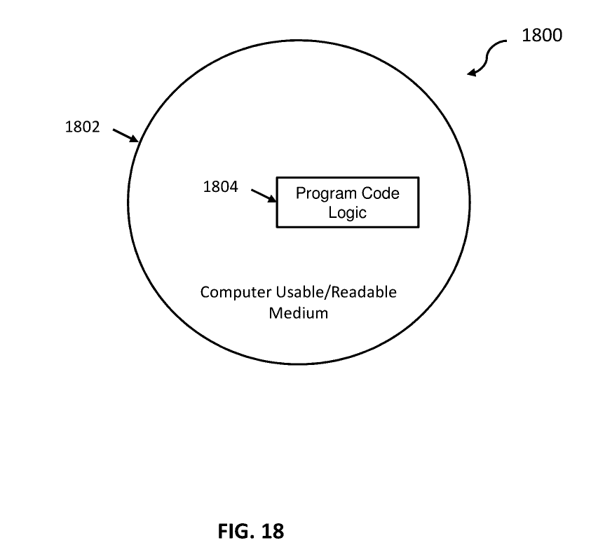

Referring now to FIG. 18, a computer program product 1800 is depicted. In accordance with an embodiment, compute program product 1800 may include a computer readable storage medium 1802 and program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It will be understood that those skilled in the art, both now and in the future, may make various improvements and enhancements which fall within the scope of the claims which follow.

1. A computer-based system for assimilating simulated genome populations, comprising:
an input circuit configured to receive an input distribution of a simulated population matrix having a first marker resolution;
a memory; and
a processor system communicatively coupled to the memory and the input circuit the processor system configured to:
receive the input distribution;
assign, for each marker of the simulated population matrix, a minor allele frequency;
assign a linkage disequilibrium for each marker and each distance of the population matrix;
assimilate the minor allele frequency, the linkage disequilibrium; and
output a genetic marker dataset for a simulated population matrix having a second markers resolution.

2. The system of claim 1, wherein
the linkage disequilibrium frequencies are not included in the input distribution; and
the second marker resolution is higher than the first marker resolution.

3. The system of claim 1, wherein the genetic marker dataset for the population matrix having a second marker resolution is based on the assimilated minor allele frequency, the linkage disequilibrium.

4. The system of claim 3, wherein the processor system is further configured to generate and output the simulated population matrix using an incremental scaling algorithm.

5. The system of claim 4, wherein the incremental scaling algorithm comprises an integer programming solver.

6. The system of claim 4, wherein:
the simulated population matrix comprises rows and columns, wherein each of the rows identifies an individual and
each of the columns represents a particular marker on a genome.

7. The system of claim 6, wherein the particular marker comprises a pair of nucleotides.

8. The system of claim 1, wherein the assignment, for each marker of the simulated population matrix, of the minor allele frequency imposes a limit on the assignment, for each marker and each distance of the simulated population matrix, of the linkage disequilibrium.

9-16. (canceled)

17. A non-transitory computer-readable medium comprising instructions executable to cause a processor to perform a method for assimilating simulated genome populations, the method comprising:
receiving, using an input circuit, an input distribution of a simulated population matrix having a first marker resolution;
assigning, for each marker of the simulated population matrix, a minor allele frequency to a neighboring column of the population matrix;
assigning a linkage disequilibrium for each marker and each distance of the population matrix;
assimilating the minor allele frequency, the linkage disequilibrium linkage disequilibrium; and
outputting a genetic marker dataset for a simulated population matrix having a second markers resolution.

19. The non-transitory computer-readable medium of claim 17, wherein
the linkage disequilibrium frequencies are not included in the input distribution; and
the second marker resolution is higher than the first marker resolution.

20. The non-transitory computer-readable medium of claim 19, wherein the genetic marker dataset for the population matrix having a second marker resolution is based on the assimilated minor allele frequency and the linkage disequilibrium.
